(19) United States
(12) Patent Application Publication
(10) Pub. No.: US 2026/0026431 A1
(43) Pub. Date: Jan. 29, 2026

(54) TRIMMER HEAD ASSEMBLY HAVING AN INTEGRATED MOTOR

(71) Applicant: Milwaukee Electric Tool Corporation, Brookfield, WI (US)

(72) Inventors: Beth E. Cholst, Wauwatosa, WI (US); Earl M. Ortt, Menomonee Falls, WI (US)

(21) Appl. No.: 19/275,035

(22) Filed: Jul. 21, 2025

Related U.S. Application Data
(60) Provisional application No. 63/675,304, filed on Jul. 25, 2024.
(60) Provisional application No. 63/679,818, filed on Aug. 6, 2024.

(51) Int. Cl. A01D 34/416; A01D 34/90; A01D 69/02

(52) U.S. Cl. CPC A01D 34/416; A01D 34/90; A01D 69/02

(57) ABSTRACT

Trimmer head assemblies and trimmers are provided. A trimmer head assembly includes a trimmer head that has a housing and a spool positioned within the housing. The spool includes a first flange portion, a second flange portion, and a body portion extending between the first flange portion and the second flange portion. The spool defines a cavity extending through the first flange portion, the second flange portion, and the body portion. The trimmer head assembly further includes a motor positioned in the cavity.

### CROSS-REFERENCE TO RELATED APPLICATIONS

This application is a non-provisional application claiming the benefit of priority under 35 U.S.C. § 119 (e) to U.S. Provisional Application No. 63/675,304, filed on Jul. 25, 2024, and U.S. Provisional Application No. 63/679,818, filed on Aug. 6, 2024, which are hereby incorporated by reference in their entirety.

### FIELD

The present disclosure relates generally to trimmer heads for trimmers. More particularly, the present disclosure relates to an integrated motor and trimmer head assembly for a trimmer.

### BACKGROUND

Power tools are generally used to perform manual operations while reducing the required amount of manual labor. For example, trimmers can be utilized for trimming grass and weeds. Trimmers generally utilize a trimmer head that houses a trimmer line. The head is spun (e.g., by a motor) at high speed, which enables the trimmer line to break the grass and weeds. The motor is often housed within a motor housing proximate a grip and/or handle of the trimmer. Alternatively, the motor may be positioned directly outside of the trimmer head and connected thereto with a drive shaft. Accordingly, trimmer heads having a more compact form factor would be welcome in the art. Particularly, an integrated motor and trimmer head assembly is desired and would be appreciated in the art.

### BRIEF DESCRIPTION

Aspects and advantages of the trimmer head assemblies and trimmers in accordance with the present disclosure will be set forth in part in the following description, or may be obvious from the description, or may be learned through practice of the technology.

In accordance with one embodiment, a trimmer head assembly is provided. The trimmer head assembly includes a trimmer head that has a housing and a spool positioned within the housing. The spool includes a first flange portion, a second flange portion, and a body portion extending between the first flange portion and the second flange portion. The spool defines a cavity extending through the first flange portion, the second flange portion, and the body portion. The trimmer head assembly further includes a motor positioned in the cavity.

In accordance with another embodiment, a trimmer is provided. The trimmer includes a connecting member and a trimmer head assembly that is disposed on the connecting member. The trimmer head assembly includes a trimmer head that has a housing and a spool positioned within the housing. The spool includes a first flange portion, a second flange portion, and a body portion extending between the first flange portion and the second flange portion. The spool defines a cavity extending through the first flange portion, the second flange portion, and the body portion. The trimmer head assembly further includes a motor positioned in the cavity.

These and other features, aspects and advantages of the present trimmer head assemblies and trimmers will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present trimmer head assemblies and trimmers, including the best mode of making and using the present systems and methods, directed to one of ordinary skill in the art, is set forth in the specification, which makes reference to the appended figures, in which:

FIG. 1 illustrates a trimmer in accordance with embodiments of the present disclosure;

FIG. 2 illustrates a perspective view of a trimmer head assembly in accordance with embodiments of the present disclosure;

FIG. 3 illustrates a first perspective view of a spool and a motor of a trimmer head assembly in accordance with exemplary aspects of the present disclosure;

FIG. 4 illustrates a second perspective view of a spool and a motor of a trimmer head assembly in accordance with exemplary aspects of the present disclosure;

FIG. 5 illustrates a cross-sectional view of the trimmer head assembly from along the line 5-5 shown in FIG. 2 in accordance with embodiments of the present disclosure; and

FIG. 6 illustrates a trimmer head assembly coupled to a trimmer in accordance with embodiments of the present disclosure.

### DETAILED DESCRIPTION

Reference now will be made in detail to embodiments of the present trimmer head assemblies and trimmers, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

As used herein, the term “power tool” is intended to refer to a device which is used to perform a work operation, such as cutting grass, weeds, brush, shrubs, or the like. By way of non-limiting example, power tools can include trimmers, brush cutters, edgers, hedge trimmers, string trimmers, cutters or the like. While embodiments provided below are directed to trimmers, one or more components of the trimmers described below, such as trimmer head assembly, may be utilized with one or more different types of power tools.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

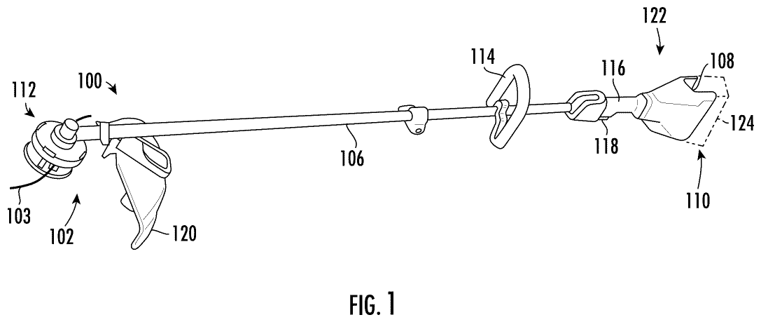

Referring now to the drawings, FIG. 1 illustrates a trimmer 100 generally including a trimmer head assembly 102, a handle assembly 122, and a connecting member 106 extending between the trimmer head assembly 102 and the handle assembly 122. While the illustrated apparatus is generally referred to herein as a “trimmer,” it should be appreciated that this is a term of convenience and can additionally, or alternatively, constitute a brush cutter, edger, hedge trimmer, string trimmer, cutter, or other similar device or power tool with alternative nomenclature.

In this regard, the trimmer head assembly 102 can include a working implement 103 that can be utilized for trimming grass, weeds, brush, shrubs, or the like. The trimmer head assembly 102 and working implement 103 can comprise a variety of different types of tools such as, for example, a string line, a blade, a disk, a cutter or the like. For example, in some embodiments, the trimmer 100 can constitute a string trimmer wherein the working implement 103 is an extendable string line. The trimmer head assembly 102 can thereby spin the string line at a high rate of speed to cut debris. In some embodiments, the trimmer 100 can constitute a brush cutter wherein the working implement 103 is a plurality blades radially extending from a central body. The trimmer head assembly 102 can thereby spin central body, and thus the plurality of radially extending blades, at a high rate of speed to cut debris. While certain types of trimmers 100 are explicitly disclosed herein, it should be appreciated that these are not intended to be limiting and other embodiments may further be realized within the scope of this disclosure.

In some embodiments, the trimmer 100 can further include a guard 120 configured to protect the operator from flying debris kicked up by the trimmer head assembly 102. In certain instances, the guard 120 can be engaged with the connecting member 106 and be disposed adjacent to the trimmer head assembly 102.

Still referring to FIG. 1, the handle assembly 122 may generally include a grip portion 116 and user interface 118 (e.g., trigger) for an operator to hold and operator the trimmer 100. In some embodiments, the trimmer 100 may extend from a first end 110 to a second end 112 with the handle assembly 122 being disposed at the first end 110 and the trimmer head assembly 102 being disposed at the second end 112 wherein the connecting member 106 (e.g., pole) extends therebetween. The connecting member 106 may be an elongated pole, such as a telescoping pole, to provide an extended reach configuration.

The grip portion 116 of the handle assembly 122 can include, for example, a portion of the handle assembly 122 including the user interface 118. The user interface 118 can include a trigger that allows the operator to selectively control the trimmer 100. The user interface 118 can further include other controls which permit the operator to effect change to the trimmer 100. For instance, by way of non-limiting example, the user interface 118 may include any one or more of a cruise control feature allowing the operator to maintain the operating speed of the trimmer head assembly 102, a turbo which allows the trimmer 100 to reach full operational speed, a power switch having at least ON and OFF functionality, a safety, or any other desirable user controls. In the illustrated embodiment, the grip portion 116 and user interface 118 are disposed between the first end 110 and the second end 112. In other embodiments, the relative arrangement of the grip portion 116, user interface 118, or other components can be varied.

The handle assembly 122 may further include one or more additional components for operation of the trimmer 100. For instance, the handle assembly 122 can include a port 108 (e.g., a battery receiving compartment or an electrical socket) and/or a motor configured to be electrically connected with a power source, such as a battery 124 or wall outlet. The port 108 is illustrated as being disposed at a first end 110 of the trimmer 100 and the trimmer head assembly 102 is disposed at a second end 112 of the trimmer 100. In other embodiments, either one or both of the port 108 or trimmer head assembly 102 can be spaced apart from the first end 110 or second end 112, respectively. In certain instances, the trimmer 100 may be electrically powered, e.g., via the battery or through a wall outlet. In other instances, the trimmer 100 may be powered by a fuel, such as gasoline.

In some embodiments, the trimmer 100 may include a secondary handle 114 to form a supplemental handle for ease of operation by an operator. The secondary handle 114 can allow the operator to support the weight of the trimmer 100 during operation. For instance, the secondary handle 114 can be disposed along the connecting member 106 to permit a second point of contact via a first hand of the operator while also holding the handle assembly 122 with the second hand of the operator.

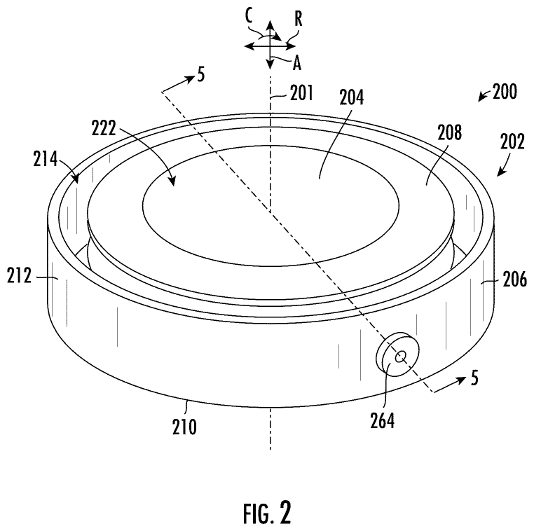

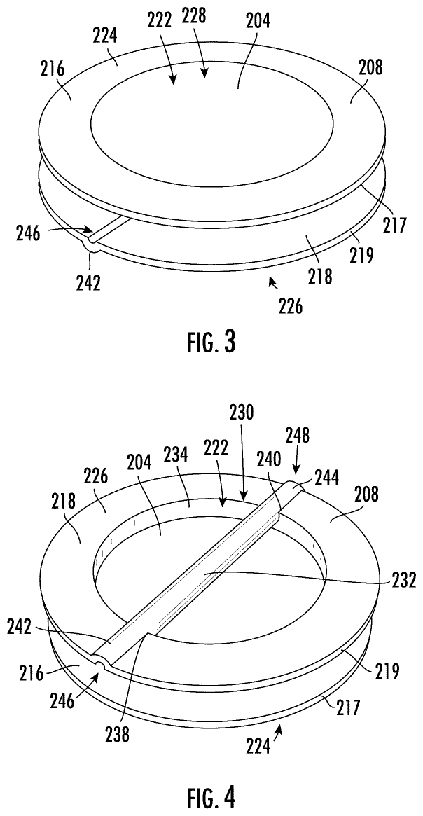

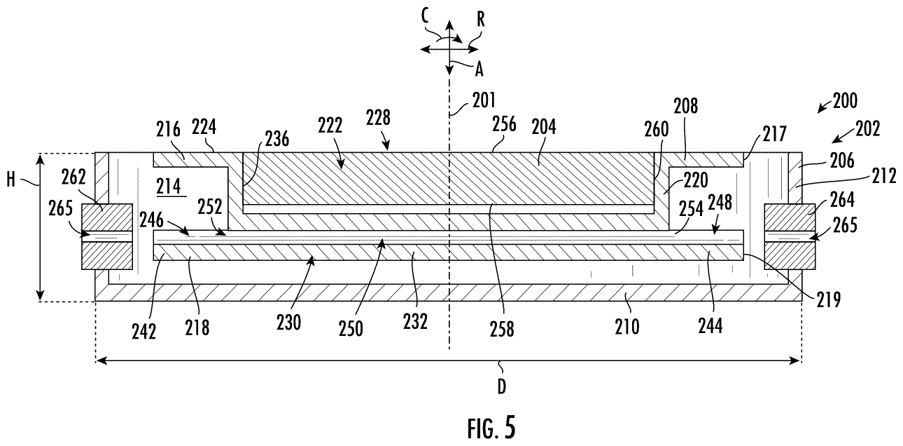

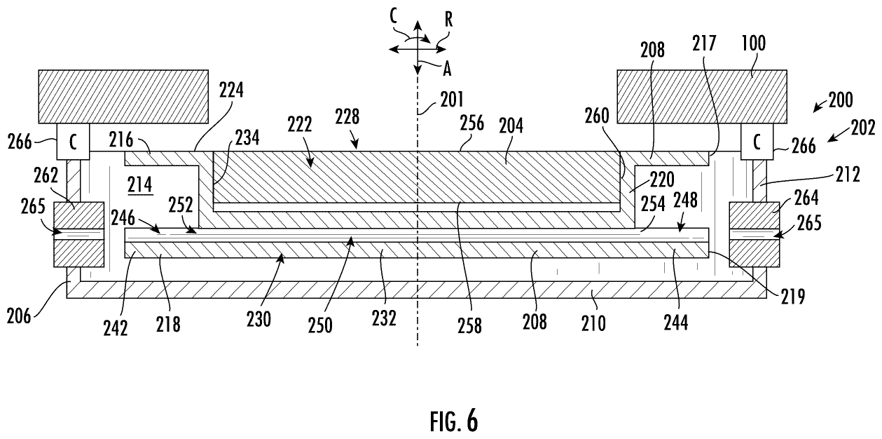

Referring now to FIGS. 2 through 6, various views of a trimmer head assembly 200, portions of the trimmer head assembly 200, and trimmers 100 are illustrated in accordance with embodiments of the present disclosure. Particularly, FIG. 2 illustrates a perspective view of the trimmer head assembly 200; FIG. 3 illustrates a top perspective view of a spool 208 and a motor 204 of the trimmer head assembly 200; FIG. 4 illustrates a bottom perspective view of the spool 208 and the motor 204; FIG. 5 illustrates a cross-sectional view of the trimmer head assembly 200 from along the line 5-5 shown in FIG. 2; and FIG. 6 illustrates a cross-sectional view of a trimmer 100 coupled to the trimmer head assembly 200.

The trimmer head assembly 200 may define and extend along an axial centerline 201. A cylindrical coordinate system may be defined relative to the axial centerline 201. The cylindrical coordinate system includes an axial direction A extending along the axial centerline 201, a radial direction R extending perpendicularly from the axial centerline 201 and the axial direction A, and a circumferential direction C extending about the axial centerline 201 and the axial direction A.

As shown in FIG. 2, the trimmer head assembly 200 may include a trimmer head 202 and the motor 204 housed within the trimmer head 202. For example, the trimmer head 202 may include a housing 206 and a spool 208 positioned or disposed within the housing 206. In many embodiments, the motor 204 may be any suitable electric motor (such as an AC motor, a DC motor, or other) powered by a power source, e.g., by a battery or other power source stored in the trimmer 100. While the motor 204 is illustrated herein as a cylinder for simplicity and discussion, it should be appreciated that the motor 204 may include a housing, a stator, a rotor, windings, an output shaft, bearings, and/or a cooling system (all of which may be positioned within the trimmer head 202). The motor 204 may cause the trimmer head assembly 200 to rotate when attached to a trimmer 100, thereby allowing trimmer line to cut leaves, bushes, and/or grass as desired.

For example, the housing 206 may include a base portion 210 and a side wall portion 212 extending base portion 210 (e.g., the side wall portion 212 may extend from an outer periphery of the base portion 210). The side wall portion 212 may be annular such that it extends about and surrounds the axial centerline 201 (e.g., the side wall portion 212 may extend circumferentially around the axial centerline 201. The base portion 210 and the side wall portion 212 may define (e.g., collectively) an interior 214 of the housing 206. The spool 208 may be positioned (e.g., entirely) within the interior 214 of the housing 206. As described in more detail below, the motor 204 may be positioned within the spool 208. For example, the spool 208 may define a cavity 222, and the motor 204 may be positioned (e.g., entirely or partially) within the cavity 222, which advantageously reduces the size and form factor of the overall trimmer head assembly 200.

As shown in FIGS. 3 through 6, the spool 208 may include a first flange portion 216, a second flange portion 218, and a body portion 220 extending (e.g., axially) between the first flange portion 216 and the second flange portion 218 (shown in FIGS. 5 and 6). The flange portions 216, 218 may be axially spaced apart from one another and may each extend radially outwardly from the body portion 220. For example, the first flange portion 216 may extend radially outwardly from the body portion 220 to a first periphery 217. Similarly, the second flange portion 218 may extend radially outwardly from the body portion 220 to a second periphery 219. During operation, trimmer line may be wound about the body portion 220 of the spool 208 between the flange portions 216, 218. The flange portions 216, 218 may bound the trimmer line to ensure the trimmer line does not fall off the body portion 220 and unwind within the housing 206.

In many embodiments, as shown, the spool 208 may further include a top surface 224 (or axially outer surface), a bottom surface 226 (or axially inner surface), and an inner surface 234 extending axially between the bottom surface 226 and the top surface 224. The top surface 224 may be defined by the first flange portion 216 of the spool 208, and the bottom surface 226 may be defined by the second flange portion 218 of the spool 208. The inner surface 234 may be annular such that it surrounds the axial centerline 201.

In exemplary embodiments, the spool 208 may define the cavity 222 extending through the first flange portion 216, the second flange portion 218, and the body portion 220. The cavity 222 may be defined by the inner surface 234 of the spool 208. In many embodiments, the cavity 222 may extend axially between a first open end 228 at the first flange portion 216 and a second open end 230 at the second flange portion 218. More specifically, the cavity 222 may extend axially between the first open end 228 at the top surface 224 of the spool 208 and the second open end 230 at the bottom surface 226 of the spool 208. The cavity 222 may extend along the axial centerline 201. In some embodiments, the cavity 222 may be centered on the axial centerline 201.

As shown in FIGS. 4-6, the spool 208 may further include a cross member 232 extending across the cavity 222. The cross member 232 may be connected to the spool 208 on either end. For example, as shown in FIG. 4, the cross member 232 may extend from a first end 238 at a first location on the inner surface 234, across the cavity 222 and through the axial centerline 201, to a second end 240 at a second location on the inner surface 234. The cross member 232 may be generally cylindrically shaped, although other shapes may be possible. The cross member 232 may extend across the cavity 222 at the second open end 230, such that the cross member 232 is positioned proximate (or at) the axial location of the second flange portion 218. The cross member 232 may extend through the axial centerline 201 of the trimmer head assembly 200 (as shown in FIGS. 5 and 6).

Additionally, as shown in FIGS. 4-6, the second flange portion 218 may define a first groove 246 and a second groove 248 diametrically opposed to one another. For example, in some embodiments, the second flange portion 218 may include protrusions 242, 244 that at least partially define grooves 246, 248. Particularly, a first protrusion 242 may at least partially define the first groove 246, and a second protrusion 244 may at least partially define the second groove 248. The protrusions 242, 244 may be shaped as half-cylinders that protrude axially from the bottom surface 226. As shown in FIG. 4, the first protrusion 242 may extend (e.g., radially) from the first end 238 of the cross member 232 to the second periphery 219. The second protrusion 248 may extend (e.g., radially) from the second end 240 of the cross member to the second periphery 219. Alternatively, the second flange portion 218 may have a sufficient thickness such that the grooves 246, 248 may be defined in the second flange portion 218 without any protrusions being necessary. The grooves 246, 248 may advantageously facilitate insertion of trimmer line into the spool 208 by providing a path along which the trimmer line can travel.

As shown in FIGS. 5 and 6, the cross member 232 may define a channel 250 extending between a first opening 252 and a second opening 254. The first groove 246 may and extend from the first opening 252 of the channel 250. Similarly, the second groove 248 may extend from the second opening 254 of the channel 250. Particularly, the first groove 246 may extend radially between the first opening 252 of the channel 250 and the second periphery 219, and the second groove 248 may extend radially between the second opening 254 of the channel 250 and the second periphery 219.

As shown in FIGS. 5 and 6, the motor 204 may include an outer surface 256, an inner surface 258, and a side surface 260. The side surface 260 may contact the spool 208 within the cavity 222. Particularly, the side surface 260 may contact the inner surface 236 of the spool 208. In some embodiments, the motor 204 may form a friction fit (or interference fit) with the spool 208 (e.g., due to the contact between the side surface 260 and the inner surface 236). In other embodiments, the motor 204 may be coupled to the spool 208 in other manners (such as via one or more fasteners). The outer surface 256 and the inner surface 258 may be exposed (e.g., such that they do not contact the spool 208 or any other components. In other embodiments, as described below in more detail, the spool 208 may be molded onto a rotor of the motor 204.

The motor 204 may be positioned entirely within the cavity 222 of the spool 208 in many embodiments. For example, the outer surface 256 of the motor 204 may be flush with the first flange portion 216 (e.g., the top surface 224 of the spool 208), such that the outer surface 256 does not protrude or project axially from the first flange portion 216. Alternatively (not shown), the motor 204 may be positioned partially within the cavity 222. For example, a majority (e.g., greater than 50%) of the motor 204 may be positioned within the cavity 222 in some embodiments. In other embodiments. A minority (e.g., less than 50%) of the motor 204 may be positioned within the cavity 222.

In various embodiments (not shown), the spool 208 (including the flange portions 216, 218 and the body portion 220) may be molded directly onto the motor 204 (e.g., molded directly onto an outer rotor of the motor 204). That is, the spool 208 and the outer rotor of the motor 204 may be unitary and integrally formed as a single component. This may advantageously improve the balancability of the assembly (e.g., make the assembly more balanced, which reduces vibrations that could otherwise lead to wear). Additionally, this may advantageously reduce the number of components thereby reducing manufacturing costs.

The cross member 232 may be positioned inward (e.g., axially inward) of the motor 204. Particularly, the cross member 232 may be axially inward of the motor 204 such that an axial gap is defined between the cross member 232 and the inner surface 258 of the motor 204. In other embodiments (not shown) the cross member 232 may contact the motor 204 and/or partially support the motor 204.

In various embodiments, as shown in FIGS. 5 and 6, the trimmer head assembly 200 may further include eyelets 262, 264 diametrically opposed to one another and connected to the housing 206. For example, a first eyelet 262 may be connected to the housing 206, and a second eyelet 264 may be connected to the housing 206 opposite the first eyelet 262. Particularly, the eyelets 262, 264 may be connected to the side wall portion 212 of the housing 206. The eyelets 262, 264 may be disposed closer to the base portion 210 of the housing 206 than a terminal end of the side wall portion 212. The eyelets 262, 264 may each define a passage 265.

As shown in FIGS. 5 and 6, trimmer line 300 may be inserted through the passage 265 of the first eyelet 262, along the first groove 246 and into the channel 250, then along the second groove 248 and through the passage 265 of the second eyelet. Subsequently, the spool 208 (and motor 204 which is connected to the spool 208) may be rotated circumferentially relative to the housing 206 to wind the trimmer line about the body portion 220 of the spool 208 (e.g., between the flange portions 216, 218).

As shown in FIG. 5, the housing 206 may define a diameter D and a height H. By integrating the motor 204 with the spool 208 (i.e., by housing the motor 204 within the spool 208), the overall form factor of the trimmer head assembly 200 may be reduced. For example, in many embodiments, the height to diameter ratio of the housing is between about 1:5 and about 1:1, or such as between about 1:5 and about 1:2, or such as between about 2:5 and about 1:2, or such as about 2:3.

As shown in FIG. 6, the housing 206 may further include a connection component 266 for connecting to the trimmer 100. The connection component 266 may allow for selective decoupling of the trimmer head assembly 200 from the trimmer 100. For example, the connection component 266 may be one or more clips that are insertable into one or more openings in the trimmer 100, such that the clips may snap in and out of the openings as desired. Alternatively, the connection component 266 may be a fastener (such as a threaded fastener). Further, in some embodiments, the connection component 266 may be threads defined in the housing 206, and in such embodiments, the trimmer 100 may define corresponding threads for coupling to the trimmer head assembly 200.

In many embodiments, the trimmer head assembly 200 may be attachable to other types of power tools, such as a brush cutter, brush saw, edger, or others. For example, the spool 208 may include a threaded post to allow a brush cutter blade to be attached. Alternatively, a shaft of a rotor of the motor may extend allowing the brush cutter blade to be located directly on the rotor for increased balance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

A trimmer head assembly comprising: a trimmer head having a housing and a spool positioned within the housing, the spool having a first flange portion, a second flange portion, and a body portion extending between the first flange portion and the second flange portion, the spool defining a cavity extending through the first flange portion, the second flange portion, and the body portion; and a motor positioned in the cavity.

The trimmer head assembly as in any preceding clause, wherein the spool further comprises a cross member inward of the motor, the cross member extending across the cavity.

The trimmer head assembly as in any preceding clause, wherein the cross member defines a channel extending between a first opening and a second opening.

The trimmer head assembly as in any preceding clause, wherein the second flange portion defines a first groove and a second groove, wherein the first groove extends from the first opening of the channel, and wherein the second groove extends from to the second opening of the channel.

The trimmer head assembly as in any preceding clause, further comprising a first eyelet and a second eyelet diametrically opposed from one another and connected to the housing, the first eyelet and the second eyelet each defining a passage.

The trimmer head assembly as in any preceding clause, wherein the motor is positioned entirely in the cavity such that an outer surface of the motor is flush with the first flange.

The trimmer head assembly as in any preceding clause, wherein the motor includes an outer surface, an inner surface, and a side surface, wherein the side surface contacts the spool in the cavity.

The trimmer head assembly as in any preceding clause, and wherein the outer surface and the inner surface are exposed.

The trimmer head assembly as in any preceding clause, wherein the housing defines a diameter and a height, and wherein the height to diameter ratio of the housing is between about 1:5 and about 1:1.

The trimmer head assembly as in any preceding clause, wherein the housing includes a connection component for connecting to a trimmer.

A trimmer comprising: a connecting member; and a trimmer head assembly disposed on the connecting member, the trimmer head assembly comprising: a trimmer head having a housing and a spool positioned within the housing, the spool having a first flange portion, a second flange portion, and a body portion extending between the first flange portion and the second flange portion, the spool defining a cavity extending through the first flange portion, the second flange portion, and the body portion; and a motor positioned in the cavity.

The trimmer as in any preceding clause, wherein the spool further comprises a cross member inward of the motor, the cross member extending across the cavity.

The trimmer as in any preceding clause, wherein the cross member defines a channel extending between a first opening and a second opening.

The trimmer as in any preceding clause, wherein the second flange portion defines a first groove and a second groove, wherein the first groove extends from the first opening of the channel, and wherein the second groove extends from to the second opening of the channel.

The trimmer as in any preceding clause, further comprising a first eyelet and a second eyelet diametrically opposed from one another and connected to the housing, the first eyelet and the second eyelet each defining a passage.

The trimmer as in any preceding clause, wherein the motor is positioned entirely in the cavity such that an outer surface of the motor is flush with the first flange.

The trimmer as in any preceding clause, wherein the motor includes an outer surface, an inner surface, and a side surface, wherein the side surface contacts the spool in the cavity.

The trimmer as in any preceding clause, and wherein the outer surface and the inner surface are exposed.

The trimmer as in any preceding clause, wherein the housing defines a diameter and a height, and wherein the height to diameter ratio of the housing is between about 1:5 and about 1:1.

The trimmer as in any preceding clause, wherein the housing includes a connection component for connecting to a trimmer.

What is claimed is:

1. A trimmer head assembly comprising:
a trimmer head having a housing and a spool positioned within the housing, the spool having a body portion, the spool defining a cavity extending through the body portion; and
a motor positioned in the cavity.

2. The trimmer head assembly as in claim 1, wherein spool further comprises a first flange portion and a second flange portion, wherein the body portion extends between the first flange portion and the second flange portion, and wherein the cavity extends through the first flange portion, the second flange portion, and the body portion.

3. The trimmer head assembly as in claim 2, wherein the spool further comprises a cross member inward of the motor, the cross member extending across the cavity.

4. The trimmer head assembly as in claim 3, wherein the cross member defines a channel extending between a first opening and a second opening.

5. The trimmer head assembly as in claim 4, wherein the second flange portion defines a first groove and a second groove, wherein the first groove extends from the first opening of the channel, and wherein the second groove extends from to the second opening of the channel.

6. The trimmer head assembly as in claim 1, further comprising a first eyelet and a second eyelet diametrically opposed from one another and connected to the housing, the first eyelet and the second eyelet each defining a passage.

7. The trimmer head assembly as in claim 1, wherein the motor is positioned entirely in the cavity.

8. The trimmer head assembly as in claim 1, wherein the motor includes an outer surface, an inner surface, and a side surface, wherein the side surface contacts the spool in the cavity.

9. The trimmer head assembly as in claim 8, and wherein the outer surface and the inner surface are exposed.

10. The trimmer head assembly as in claim 1, wherein the housing defines a diameter and a height, and wherein the height to diameter ratio of the housing is between about 1:5 and about 1:1.

11. The trimmer head assembly as in claim 1, wherein the housing includes a connection component for connecting to a trimmer.

12. A trimmer comprising:
a connecting member; and
a trimmer head assembly disposed on the connecting member, the trimmer head assembly comprising:
a trimmer head having a housing and a spool positioned within the housing, the spool having a body portion, the spool defining a cavity extending through the body portion; and
a motor positioned in the cavity.

13. The trimmer as in claim 12, wherein spool further comprises a first flange portion and a second flange portion, wherein the body portion extends between the first flange portion and the second flange portion, and wherein the cavity extends through the first flange portion, the second flange portion, and the body portion.

14. The trimmer as in claim 13, wherein the spool further comprises a cross member inward of the motor, the cross member extending across the cavity.

15. The trimmer as in claim 14, wherein the cross member defines a channel extending between a first opening and a second opening.

16. The trimmer as in claim 15, wherein the second flange portion defines a first groove and a second groove, wherein the first groove extends from the first opening of the channel, and wherein the second groove extends from to the second opening of the channel.

17. The trimmer as in claim 12, further comprising a first eyelet and a second eyelet diametrically opposed from one another and connected to the housing, the first eyelet and the second eyelet each defining a passage.

18. The trimmer as in claim 12, wherein the motor is positioned entirely in the cavity.

19. The trimmer as in claim 12, wherein the motor includes an outer surface, an inner surface, and a side surface, wherein the side surface contacts the spool in the cavity.

20. The trimmer as in claim 19, and wherein the outer surface and the inner surface are exposed.
